(19) United States
(12) Patent Application Publication
(10) Pub. No.: US 2013/0266726 A1
(43) Pub. Date: Oct. 10, 2013

(54) Methods of Applying and Mass Producing Nanoparticles to an Interior of an Internal Combustion Engine to Increase the Efficiency of said Internal Combustion Engine

(71) Applicant: Ransen GARDENIER, Troy, NY (US)

(72) Inventor: Ransen GARDENIER, Troy, NY (US)

(21) Appl. No.: 13/907,852

(22) Filed: May 31, 2013

Related U.S. Application Data
(63) Continuation-in-part of application No. 12/267,140, filed on Nov. 7, 2008, now Pat. No. 8,490,583.
(60) Provisional application No. 61/653,958, filed on May 31, 2012.

(51) Int. Cl. F02B 47/04

(52) U.S. Cl. CPC F02B 47/04
USPC 427/140; 44/603

(57) ABSTRACT

A fuel additive is poured into a vehicle's fuel tank and contains invisible nanoparticles or strings. The fuel additive is non-hazardous, which allows for around-the-world quick and safe shipping. The nanoparticles do not clog (the nanoparticles is under one micron in size) and are able to pass thru filler-pipe impediments and sender equipment's cloth filters and freely mix (entrain themselves) uniformly throughout the fuel tank through Boyle's Law, while remaining in constant suspended motion (by Brownian motion).

The current application claims a priority to 61/653,958 filed on May 31, 2012.

The current application is a continuation-in-part of and claims a priority to Ser. No. 12/267,140 filed on Nov. 7, 2008, which claims a priority to 61/022,347 filed on Nov. 7, 2007 and a priority of 61/058,591 filed on Jun. 4, 2008.

### FIELD OF THE INVENTION

The present invention relates generally to a chemical composition for a fuel additive. More specifically, the present invention is a nanoparticle that fills piston and cylinder walls of a combustion engine.

### BACKGROUND OF THE INVENTION

Albert Einstein said, “I could fly a spaceship to Pluto and back, with the energy [contained] in one gallon of gas.” The internal combustion engine is a device in which chemical energy is converted into mechanical energy. Fuel is combusted within several combustion chambers creating a force which moves pistons, turbine blades, etc. While many different types of internal combustion engines are used in a variety of applications, they do not operate at a high rate of efficiency. This inefficiency is often due to ridges within the cylinder, which causes a decrease in the lubricity between the piston and cylinder. As a result fuel additives have been developed in an attempt to increase the efficiency of internal combustion engines. These fuel additives increase the lubricity of the fuel and/or the efficiency of burning the fuel within the engine. One conventional fuel additive is acetone, which is believed to aid in the vaporization of fuel. While these fuel additives may be somewhat effective, their effectiveness is limited to only a single tank of gas. This requires that fuel treatments be made every time the fuel tank is filled in order to increase the efficiency of the engine. This can also result in wasted fuel additive, as many individuals fill up their fuel tank prior to it being empty.

Therefore it is an object of the present invention to provide a method for increasing the efficiency of an internal combustion engine. The present invention relates generally to a fuel additive having a plurality of nanoparticles. The plurality of nanoparticles dissolves within the fuel and form a coating within the piston and cylinder walls, which acts to smooth out the ridges formed within the piston and cylinder walls. As a result, the combustion containment between the piston and the cylinder is increased, allowing the internal combustion engine to convert more chemical energy into mechanical energy. The present invention also provides a method for mass producing the plurality of nanoparticles found within the fuel additive.

### BRIEF DESCRIPTION OF THE DRAWINGS

FIG. 1 is a flow chart describing the method of applying nanoparticles to an interior of an internal combustion engine.

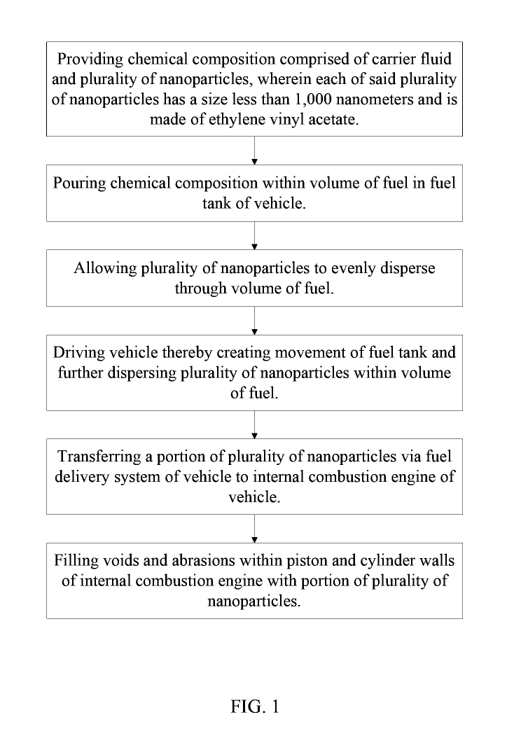

FIG. 2 is a flow chart describing the method of mass producing nanoparticles.

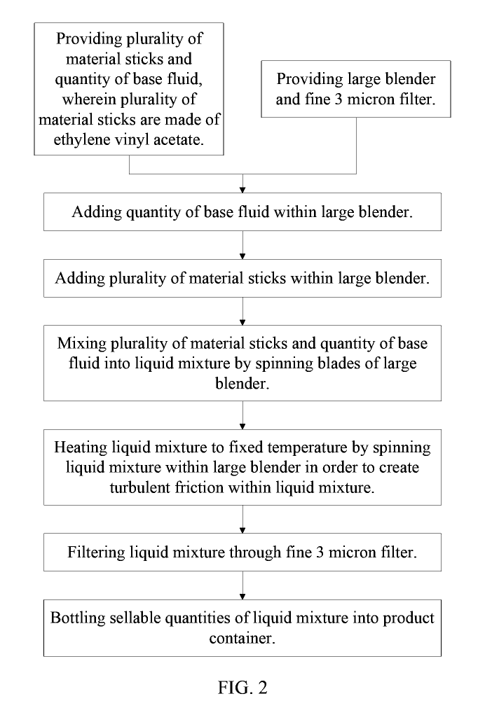

FIG. 3 is an illustration of the large blender used in the method of mass producing nanoparticles.

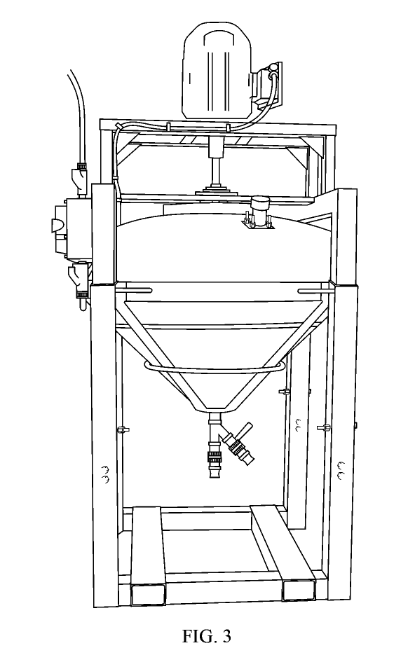

### DETAILED DESCRIPTIONS OF THE INVENTION

All illustrations of the drawings are for the purpose of describing selected versions of the present invention and are not intended to limit the scope of the present invention.

The present invention is a method of applying nanoparticles to the interior of an internal combustion engine in order to increase the efficiency of the internal combustion engine. A chemical composition is provided for this method and creates improved containment for the quick burn explosions created by the internal combustion engine. The chemical composition acts as a fuel additive pour-in. The chemical composition comprises a plurality of nanoparticles and a carrier fluid. Each of the plurality of nanoparticles is specifically made of ethylene vinyl acetate (EVA) and has a size of less than 1,000 nanometers, which allows these nanoparticles to easily pass through the fuel filter system of a vehicle. EVA is a non-flammable substance and is safe for everyday use. The plurality of nanoparticles is the primary means to increase the efficiency of the internal combustion engine, and the carrier fluid is the means of transferring the plurality of nanoparticles into a volume of fuel. Thus, the plurality of nanoparticles must be soluble in fuel. In the preferred embodiment, the carrier fluid is mineral oil, which allows the chemical composition to be non-flammable and non-hazardous. In another embodiment, the carrier fluid is a generic distillate additive, which is typically used to improve engine performance in other ways such as increasing the octane for the volume of fuel or separating water out of the volume of fuel. The carrier fluid as a generic distillate additive is a flammable, hazardous alternative to mineral oil, but will still allow the plurality of nanoparticles to provide improved containment within the internal combustion engine.

The chemical composition allows a vehicle to have improved containment within the internal combustion engine over a period of accumulated mileage. In the preferred embodiment, the chemical composition is sold in an 8 ounce quantity and is a time released product that needs to be replenished every 6,000 miles for a vehicle. In order to begin improving the containment within the internal combustion engine, the chemical composition needs to be poured within the fuel tank of the vehicle, which allows the carrier fluid to transport the plurality of nanoparticles into a volume of fuel. The plurality of nanoparticles is then allowed to evenly disperse through the volume of fuel via Boyle's law. Once the plurality of nanoparticles is within the fuel tank, the vehicle can be driven in order to create movement within the fuel tank, which will further disperse the plurality of nanoparticles within the volume of fuel. The plurality of nanoparticles will then be suspended with the fuel via Brownian motion or the random bombardment of fuel molecules on each of the nanoparticles. Each of the plurality of nanoparticles will be entrained with the carrier fluid. If the plurality of nanoparticles is suspended within the volume of fuel, then the plurality of nanoparticles will behave more fluid-like instead of solid-like, which is important because standardized regulation prohibits solids within the fuel tank of a vehicle. These standardized regulation followed by the Society of Automotive Engineers, the Department of Transportation, and Federal Trade Commission.

Once the internal combustion engine is running, the fuel delivery system of the vehicle will transfer a portion of the plurality of nanoparticles to the vehicle's internal combustion engine. This portion of the nanoparticles will fill in voids and abrasions within the piston and cylinder walls of the internal combustion engine, which would improve the combustion containment of the internal combustion engine. Thus, the plurality of nanoparticles serves the same purpose as the piston ring, which is to provide tighter combustion containment. As an additional benefit, the portion of the nanoparticles also lubricates the piston and cylinder walls in order to decrease the friction within the internal combustion engine.

The nature of EVA dictates the method of mass producing nanoparticles that are applied to the interior of an internal combustion engine. The initial ingredients for mass producing these nanoparticles are a plurality of material sticks and a quantity of base fluid. The plurality of material sticks is made of EVA. In preferred embodiment, each of the plurality of material sticks has a circular cross section with a radius of 0.25 inches and a length of 4 inches and, thus, has a volume of 0.25 π inches cubed. The quantity of base fluid is actually the carrier fluid found in the chemical composition with the plurality of nanoparticles. Consequently, the quantity of base fluid can be either non-hazardous with the mineral oil or hazardous with the generic distillate additive. The necessary equipment for mass producing these nanoparticles is a large blender and a fine 3 micron filter. In the preferred embodiment, the large blender has a holding volume of 160 gallons. The method of mass producing these nanoparticles begins by adding the quantity of base fluid into the large blender as a solvent of the chemical composition. The plurality of material sticks is then added into the large blender. In preferred embodiment, the proper ratio to be mixed in the blender is 2 material sticks for every 8 ounces of liquid mixture. Once the initial ingredients are within the large blender, the plurality of material sticks and the quantity of base fluid is mixed together by spinning the blades of the blender. The top-down dissolution of the plurality of material sticks within the quantity of base fluid creates a liquid mixture. This liquid mixture is also heated to a fixed temperature by rapidly spinning the blades of the blender and creating turbulent friction within the liquid mixture. The temperature of the liquid mixture is raised from the room temperature to the fixed temperature because organic compounds such as EVA become soluble at higher temperatures. Thus, the blades of the large blender chops, whips, breaks, and heats the plurality of material sticks in order to create the plurality of nanoparticles. The liquid mixture is then filtered through the fine 3 micron filter in order separate the larger particles of EVA from the plurality of nanoparticles. Finally, the liquid mixture is divided into sellable quantities and bottled into a product container, each of which can hold one sellable quantity.

An alternative method of producing the chemical composition with the plurality of nanoparticles does not require a large blender or a fine 3 micron filter. The alternative method simply heats the mineral oil to a light boil and then gently stirs the EVA into the mineral oil.

On May 6, 2004, the Rev. Mims (Texas) moth-ball scammed thousands, and forced the Society of Automotive Engineers, the Department of Transportation, and Federal Trade Commission to ban as additives, any “solids in the gas tank.” EVA is a solid but a safe additive, and comprises materials used in mouth-guards by thousands of youngsters and adults every day. The mineral oil is a safe liquid, even used as an intestinal lubricant. Both components are oil-based. Therefore, the chemical composition in one embodiment is able to provide a top-down down-size solid EVA by “dissolution” in hot mineral oil. Thus, a safe mix of nanoparticles is provided, creating a safe additive.

Although the invention has been explained in relation to its preferred embodiment, it is to be understood that many other possible modifications and variations can be made without departing from the spirit and scope of the invention as hereinafter claimed.

What is claimed is:

1. A method of applying nanoparticles to an interior of an internal combustion engine to increase the efficiency of said internal combustion engine, the method comprises the steps of:
providing a chemical composition comprised a carrier fluid and a plurality of nanoparticles, wherein each of said plurality of nanoparticles has a size less than 1,000 nanometers and is made of ethylene vinyl acetate;
pouring said chemical composition within a volume of fuel in a fuel tank of a vehicle;
allowing said plurality of nanoparticles to evenly disperse through said volume of fuel;
driving said vehicle thereby creating movement of said fuel tank and further dispersing said plurality of nanoparticles within said volume of fuel;
transferring a portion of said plurality of nanoparticles via a fuel delivery system of said vehicle to an internal combustion engine of said vehicle; and
filling voids and abrasions within piston and cylinder walls of said internal combustion engine with said portion of said plurality of nanoparticles.

2. The method of applying nanoparticles to an interior of an internal combustion engine of claim 1, wherein said portion of said plurality of nanoparticles fills said voids and abrasions within said piston and cylinder walls in order to improve combustion containment for said internal combustion engine.

3. The method of applying nanoparticles to an interior of an internal combustion engine of claim 1, wherein said plurality of nanoparticles is soluble in a fuel.

4. The method of applying nanoparticles to an interior of an internal combustion engine of claim 1, wherein each of said plurality of nanoparticles is entrained within said carrier fluid.

5. The method of applying nanoparticles to an interior of an internal combustion engine of claim 1, wherein said carrier fluid is a mineral oil.

6. The method of applying nanoparticles to an interior of an internal combustion engine of claim 5, wherein said mineral oil is non-hazardous and non-flammable.

7. The method of applying nanoparticles to an interior of an internal combustion engine of claim 1, wherein said carrier fluid is a generic distillate additive used to improve engine performance.

8. The method of applying nanoparticles to an interior of an internal combustion engine of claim 1, wherein said plurality of nanoparticles is suspended within said fuel via Brownian motion.

9. The method of applying nanoparticles to an interior of an internal combustion engine of claim 1, wherein said plurality of nanoparticles disperses through said volume of fuel via Boyle's law.

10. The method of applying nanoparticles to an interior of an internal combustion engine of claim 1, wherein said portion of said plurality of nanoparticles lubricates said piston and cylinder walls in order to decrease friction within said internal combustion engine.

11. A method of mass producing nanoparticles that are applied to an interior of an internal combustion engine, the method comprises the steps of:
providing a plurality of material sticks and a quantity of base fluid, wherein said plurality of material sticks is made of ethylene vinyl acetate;
providing a large blender and a fine 3 micron filter;
adding said quantity of base fluid within said large blender;
adding said plurality of material sticks within said large blender;
mixing said plurality of material sticks and said quantity of base fluid into a liquid mixture by spinning blades of said large blender;
heating said liquid mixture to a fixed temperature by rapidly spinning said liquid mixture within said large blender in order to create turbulent friction within said liquid mixture;
filtering said liquid mixture through said fine 3 micron filter; and
bottling sellable quantities of said liquid mixture into a product container.

12. The method of mass producing nanoparticles that are applied to an interior of an internal combustion engine, the method as claimed in claim 11, wherein said large blender has a volume of 160 gallons.

13. The method of mass producing nanoparticles that are applied to an interior of an internal combustion engine, the method as claimed in claim 11, wherein a proper ratio between said plurality of material sticks and said base fluid is 2 material sticks for every 8 ounces of liquid mixture.

14. The method of mass producing nanoparticles that are applied to an interior of an internal combustion engine, the method as claimed in claim 13, wherein each of said plurality of material sticks has a volume of 0.25 π inches cubed.

15. The method of mass producing nanoparticles that are applied to an interior of an internal combustion engine, the method as claimed in claim 11, wherein said base fluid is a mineral oil.

16. The method of mass producing nanoparticles that are applied to an interior of an internal combustion engine, the method as claimed in claim 11, wherein said base fluid is a generic distillate additive used to improve engine performance.

17. The method of mass producing nanoparticles that are applied to an interior of an internal combustion engine, the method as claimed in claim 11 comprises the step of:
chopping, whipping, breaking, and heating said plurality of material sticks into a plurality of nanoparticles by spinning said blades of said large blender.
